(19) United States
(12) Patent Application Publication
(10) Pub. No.: US 2008/0193693 A1
(43) Pub. Date: Aug. 14, 2008

(54) Anti-stab and antiballistic foraminous structures

(75) Inventor: Allan D. Bain, Missouri City, TX (US)

Correspondence Address: SCHUBERT OSTERRIEDER & NICKELSON PLLC, 6013 CANNON MTN DR, S14, AUSTIN, TX, 78749, US

(73) Assignee: US Armor Corporation

(21) Appl. No.: 11/706,509

(22) Filed: Feb. 14, 2007

(51) Int. Cl. B32B 9/04; B32B 27/00; B32B 27/34; B32B 33/00

(52) U.S. Cl. 428/40.1; 428/411.1; 428/446; 428/457; 428/474.4; 428/500; 428/688; 428/689; 442/181; 442/327

(57) ABSTRACT

Penetration-resistant devices are disclosed. One example embodiment includes a first substrate having a light weight and a high tensile strength. Further, the embodiment includes a second substrate also having a light weight and a high tensile strength. Further still, the embodiment includes an adhesive substance that is located between the first substrate and the second substrate. Yet further, the embodiment includes a plurality of foraminous structures in contact with the adhesive and between the first substrate and the second substrate. Example embodiments may include the foraminous structures arranged in an imbricated pattern, where each of the foraminous structures have individual shapes, such as perforated hexagons and circles. In some embodiments, the substrates may be more than two, but like a two-substrate device, an adhesive is located between each successive pairs of substrates. The devices may be adhered to articles of manufacture to provide such with anti-stab and/or antiballistic properties.

### FIELD OF INVENTION

The invention generally relates to penetration-resistant materials, and, in particular, to foraminous structures capable of use in anti-stab, antiballistic and/or other high-modulus, high-strength applications.

### BACKGROUND

Throughout history, various types of substances have been used as body armors to protect humans from injury in combat and other hostile situations. From earliest times, protective vests were made from animal skins and hides. As time and technology progressed, wooden and metal vests were used as body protection. These armors were cumbersome, heavy and uncomfortable, which collectively suggested a desired need for soft, more effective, and lightweight body armors. Modern civilization has responded and continues to respond to this need through research and development of high-performance, laminated fibers (“laminates”) which have extinguished former and sole reliance on wood and animal hides to provide protective applications.

Today, body armor laminates are often constructed from one or more layers of ballistic resistant material(s), such as polyethylene, polyolefin and aramid fibers, sometimes in combination with resin, to produce a wearable, soft body armor laminate that protects a wearer against high-velocity bullets and fragments. In addition, these soft body armor laminates are occasionally amplified in strength by removably or permanently appending them to a ballistic panel or substrate, otherwise more generically known as a ballistic composite, such as metal or ceramic.

Despite advances in antiballistic and anti-stab devices, whether used in soft or hard body armor, problems remain in providing their underlying purpose, i.e., antiballistic and anti-stab protection against “hits,” whether viewed as “fair” or “unfair” according to known industry standard tests definitions. In the real world, criminals, terrorists, and antiballistic vest wearers are not concerned with whether a bullet or stab is a “fair” or “unfair” hit if the bullet or stab kills or mutilates the antiballistic or anti-stab laminate wearer. In addition, another problem is ever-present in finding low weight, high tensile strength, flexible and cost-efficient devices having real antiballistic and anti-stab capabilities. Still another problem is absorption of water by alleged antiballistic and/or anti-stab materials, a problem known to lower ballistic performance by as much as 40% as compared to an anhydrous version of some antiballistic and/or anti-stab materials.

In light of the above-listed and known example problems, a need, therefore, exists for improved laminate structures that are capable of enhanced antiballistic and/or anti-stab applications while being low weight, high tensile strength, flexible and cost-efficient, as well as being sufficiently.

### SUMMARY OF THE INVENTION

Anti-stab and/or antiballistic devices are disclosed. One example embodiment includes a first substrate having a light weight and a high tensile strength. Further, the embodiment includes a second substrate also having a light weight and a high tensile strength. Further still, the embodiment includes an adhesive substance that is located between the first substrate and the second substrate. Yet further, the embodiment includes a plurality of foraminous structures in contact with the adhesive and between the first substrate and the second substrate. In certain embodiments, the foraminous structures may be arranged in an imbricated pattern, where each of the foraminous structures have individual shapes, such as hexagons or circles perforated with lines or holes. In some embodiments, the substrates may be more than two, but like a two-substrate device, an adhesive is located between each successive pairs of substrates. The devices may be adhered to articles of manufacture to provide such with anti-stab and/or antiballistic properties.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical, example embodiments of this invention and are therefore not to be considered limiting of its scope, for the invention may admit to other equally effective embodiments.

FIG. 1 is a side-view of two-substrate antiballistic and/or anti-stab device with optional water-repellant coatings as further discussed herein and in accordance with the disclosed invention.

FIG. 2 is an exploded view of a portion of the plurality of hexagonally shaped foraminous structures arranged in an imbricated pattern as further discussed herein and in accordance with the disclosed invention.

FIG. 3 is an exploded view of a portion of the plurality of foraminous structures, each of which have a circular shape, arranged in an imbricated pattern as further discussed herein and in accordance with the disclosed invention.

FIG. 4A depicts one of the plurality of foraminous structures having a square shape and having a plurality of oval-shaped foramen as further discussed herein and in accordance with the disclosed invention.

FIG. 4B depicts one of the plurality of foraminous structures having a triangular shape and having a plurality of foramen that are densely packed and circular in shape as further discussed herein and in accordance with the disclosed invention.

FIG. 4C depicts one of the plurality of foraminous structures having a crescent shape and having a plurality of line-shaped foramen as further discussed herein and in accordance with the disclosed invention.

FIG. 5A depicts a plain weave pattern as further discussed herein and in accordance with the disclosed invention.

FIG. 5B depicts a twill weave, which is a twill-based weave, as further discussed herein and in accordance with the disclosed invention.

FIG. 5C depicts a satin weave, which is a twill-based weave, as further discussed herein and in accordance with the disclosed invention.

### DETAILED DESCRIPTION OF THE EMBODIMENTS

The following is a detailed description of example embodiments of the invention depicted in the accompanying drawings. The embodiments are examples and are in such detail so as to clearly communicate the invention. However, the amount of detail offered is not intended to limit the anticipated variations of embodiments; on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

Generally speaking, structures for antiballistic and/or anti-stab applications or other high-modulus, high-strength composite applications are contemplated that also have a light weight, and are both cost-effective and flexible. Embodiments include at least a first substrate and a second substrate held together with an adhesive that also has a plurality of foraminous structures embedded therein; that is, by analogy, the overall structure of such a device is effectively a sandwich containing a layer of plurality of foraminous structures in a particular arrangement. Typically antiballistic materials, the first substrate and the second substrate may also contain a water-repellant coating located on the exterior portions of such a two-substrate device, or, stated another way, where the adhesive is not present. In the alternative, the optional water-repellant coating may be integrated into and/or a physical attribute of the chosen adhesive for adjoining the first substrate and the second substrate with the plurality of foraminous structure therebetween. The plurality of foraminous structures has an overall arrangement with each of its individual structures having a shape, and, further each individual structure may have one or more foramen that also have individual shapes. The foregoing description generally discloses a two-substrate device that may be applied to an article of manufacture to endow such with antiballistic and/or anti-stab properties.

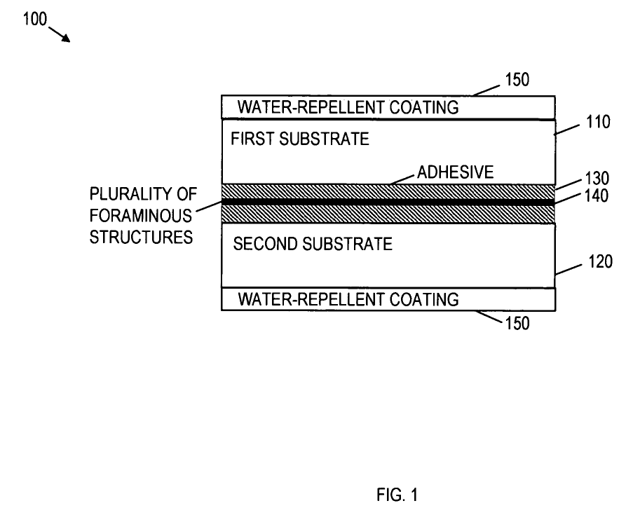

Turning now to FIG. 1, a penetration-resistant device 100 is displayed. The device 100 includes at least a first substrate 110 and a second substrate 120. The substrates 110, 120 have a light weight and high tensile strength, and are typically made from flexible antiballistic and/or anti-stab substances since the fundamental purpose of the device 100 is to serve as a penetration-resistant device 100. To that end then, the substrates 110, 120, for example, may be made from Kevlar®, Zylon®, Twaron®, EvoFlex, M5®, high-density polyethylene-based fabrics, or poly-p-phenylenebenzobisoxazole-based fabrics. In the alternative, however, non-antiballistic and/or non-anti-stab substrates 110, 120 may also be used, and an example of such is nylon. When non-antiballistic and/or non-anti-stab substances for the substrates 110, 120 are used, the device's 100 antiballistic and anti-stab properties primarily stems from the plurality of foraminous structures 140 as discussed later herein. Conversely, when antiballistic and/or anti-stab substances are used in the substrates 110, 120, the device's 100 antiballistic and anti-stab properties stem from both the plurality of foraminous structures 140 and such substances.

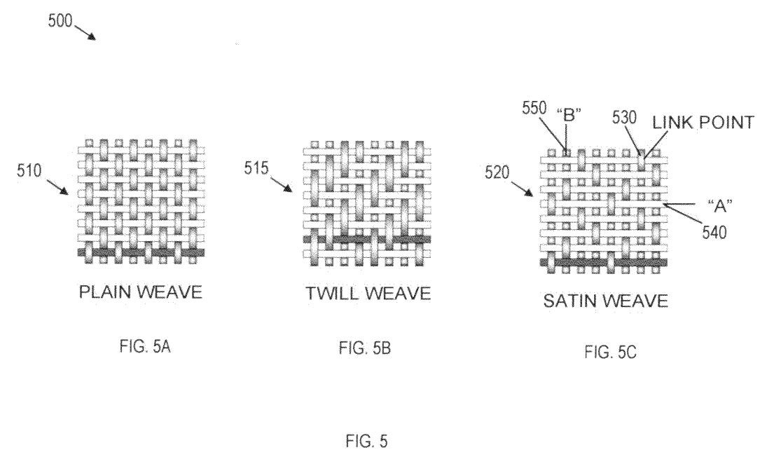

Referring now to FIGS. 5A-5C, more detail is now disclosed about the weave of acceptable fabrics for the substrates 110, 120 of the device 100 as shown in FIG. 1. The fabrics 500, whether antiballistic or not, may be plain woven 510, non-plain woven 515, 520, as shown in FIGS. 5A-5C, respectively, or even non-woven, which is not depicted. Woven materials are produced by interlacing the warp (0°) and the weft (90°) fibers, respectively depicted as “A” 540 and “B” 550 in FIG. 5C, in a particular weave pattern. The resultant mechanical interlocking of the warp and the weft fibers provides the material with its integrity; each such interlocking point is also known as a link point 530.

Now, with respect to the specific figures, FIG. 5A depicts a plain weave, wherein the depicted A-B weave pattern is one under, one over, one under, and so on. A material having plain-woven 510 fibers is symmetrical, and provides good stability and reasonable porosity. However, plain-woven 510 materials are less drapable than other weave patterns, and their high level of fiber crimp imparts relatively low mechanical properties as compared with the other weave patterns.

The materials for use in the disclosed invention may also be a twill-based weave pattern, such as the twill weave 515 pattern depicted in FIG. 5B, or, even better for the disclosed invention, the modified twill weave pattern known as a satin weave 520 as depicted in FIG. 5C. In a twill weave 510 pattern, one or more warp fibers alternately weave over and under two or more weft fibers in a regular repeated manner. This produces a visual effect of a straight or broken diagonal ‘rib’ to the fabric. Superior wet out and drape is seen in the twill weave 515 pattern as compared to the plain weave 510 with only a small reduction in stability. With reduced crimp, the fabric of a twill weave 515 also has a smoother surface and slightly higher mechanical properties than a plain weave 510.

Satin weaves 520 are fundamentally twill weaves 515 modified to produce fewer intersections of warp and weft. The ‘harness’ (“H”) number used in the designation of a satin weave 520 is the total number of fibers crossed and passed under, before the fiber repeats the pattern. Examples of such harnessed-numbered satin weaves 520 are 4H, 8H, and 20H, and FIG. 5C, itself, is an example of a 4H satin weave 520 because one fiber is crossed and three passed under before the fiber repeats the pattern; that is one plus three equals four, the H designates this as a satin weave 520, and, hence, 4H. Naturally attendant to this nomenclature is the immediate capability of determining the percent wovenness of a satin weave and the unidirectional structures percentage; for example, a 4H is 25% woven and is 75% unidirectional structures.

Generally, satin weaves 520 are very flat, have good wet out and a high degree of drape, which means a high degree ability to conform to a complex surface. The low crimp gives good mechanical properties. Satin weaves 520 allow fibers to be woven in the closest proximity and can produce materials having fibers with a close ‘tight’ weave.

Returning now to FIG. 1, the device 100, which is flexible in order to effectively dissipate the energy associated with incoming hits from bullets or stabs, also includes an adhesive 130 located between the first substrate 110 and the second substrate 120. In common parlance, the adhesive 130 is literally the glue that keeps the sandwich of substrates 110, 120 together. The adhesive 130, for example, may be an acrylic, silicone or petroleum-based adhesive. The adhesive 130 may be applied, for instance, to a side of the substrates 110, 120 through the use of a peel-off and release adhesive already known in the industry before complete construction of the device 100.

FIG. 1 also shows the device 100 to optionally include water-repellant coatings 150 on the exterior portions of each of the substrates 110, 120. The optimal water-repellant coatings 150 may be superfluous depending on the chosen adhesive 130 and/or the substances comprising the substrates 110, 120. The optional water-repellant coating(s) 150 is a repellant that fills the voids of the fabric substrates 110, 120 and adheres to the exterior portions of the fiber that prevents water from entering or adhering to the fiber at any point. For instance, if the substrates 110, 120 are made from low hygroscopic fabrics, then the addition of optional water-repellant coating(s) 150 may be either superfluous or merely additional insurance to ensure water repellency since water is known to impede antiballistic performance. In an alternative embodiment, the optional water-repellant coating(s) 150 are not located on the exterior portion(s) of substrates 110, 120 as depicted in FIG. 1, but, instead, the water repellency is integrated into or is a physical attribute of the chosen adhesive 130, e.g., a silicone rubber adhesive. In still another, alternative, example embodiment, water-repellency may be achieved by enveloping the entire device 100 in an ultrasonically woven nylon bag.

Before turning to a discussion of the layer of plurality of foraminous structures 140 embedded within the adhesive 130 and shown in various detail in FIGS. 1-4, it is noteworthy at this juncture to mention that the device 100 may be greater than a two-substrate 110, 120 device 100. That is, the device 100 may, instead, contain one or more additional substrates, wherein each of the one or more additional substrates is in contact with an adhesive and a plurality of foraminous structures as well as its closest substrate. Stated another way, the device 100 shown in FIG. 1 may be stacked by repeating the same pattern of substrate, plurality of foraminous structures with adhesive, another substrate, another plurality of foraminous structures with adhesive, and so on, with the ending device also having water-repellency as previously discussed.

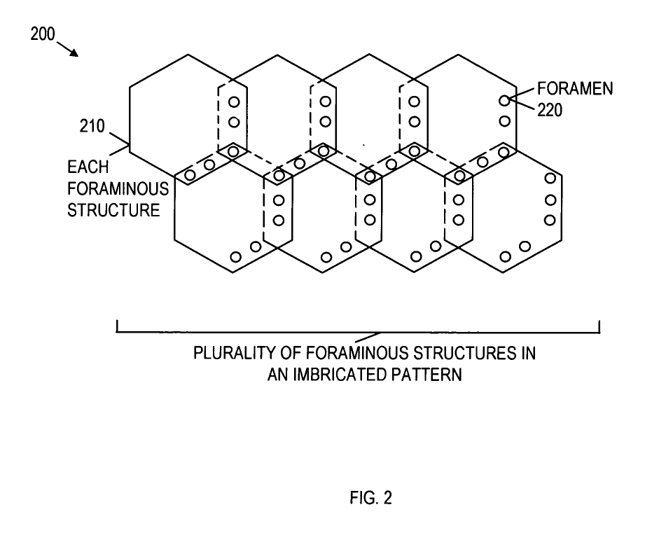

Now focus and elucidation on the plurality of foraminous structures 140 shown in FIG. 1 ensues. In the side view of the device 100 shown in FIG. 1, a layer of a plurality of foraminous structures 140 is depicted. Example, exploded portions of possible contents for this layer 140 are shown in FIGS. 2-4.

The plurality of foraminous structures 140 are ideally made from low weight materials, e.g., perforated metals or injection molded plastics, which are cheaper than textiles. Acceptable materials include titanium, aluminum, steel, one or more alloys, non-metals, nano-carbon tubes, non-porous and casted metals with tempering capabilities and powdered metal composites. Low-weight materials, as well as the flexible character previously discussed, are ideal because the device 100 is ultimately applied, for instance, by stitching or gluing, the desired shape of the device 100 to an article of manufacture that may be worn by an individual to provide that person with antiballistic and/or anti-stab protection. It is undesirable to use heavy materials because the individual has to bear the burden of the device's 100 weight, and, thus, use of heavy materials would harken back to olden days of wearing burdensome chain male. Application of a chosen shape for the device 100 may be applied, for instance, to a vest, jacket, helmet, glove, shirt, a pair of pants, a pair of shoes, or a body suit ultimately for wearing by an individual. Instead of applying a cut shape of the device 100 to articles worn by an individual, such may also be applied, such as by bolting, to vehicles to endow it with antiballistic and/or anti-stab properties. Here, example vehicles using the device 100 may be a tank or a car.

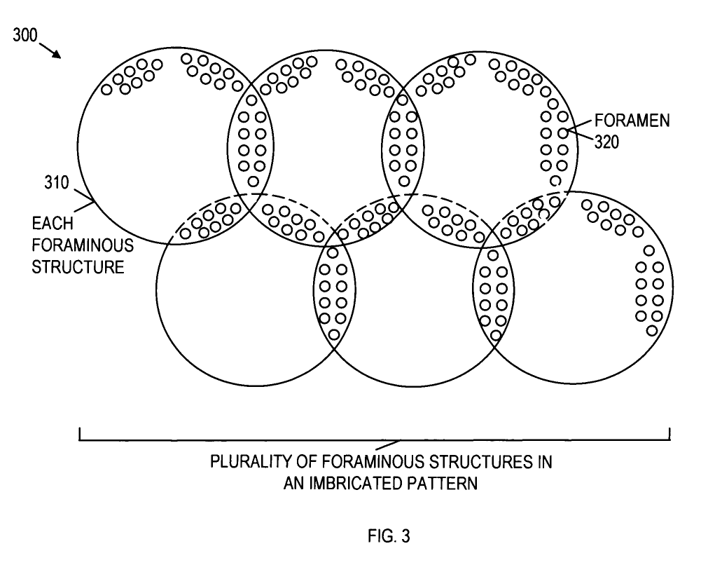

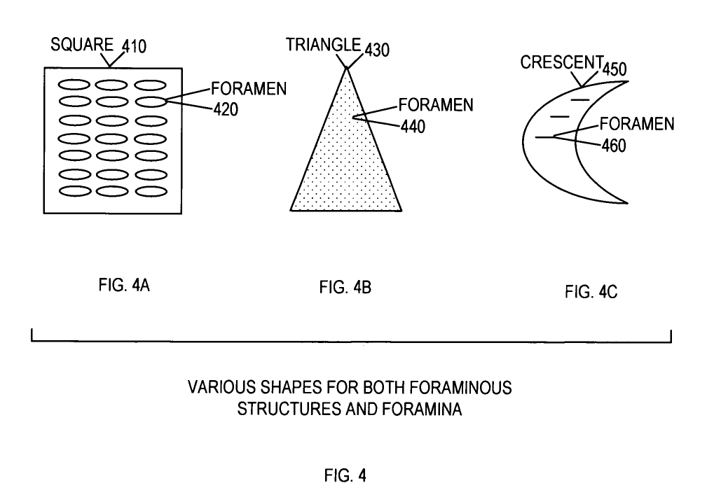

With reference to FIG. 2, an exploded view of the a section 200 of a possible configuration of the layer of plurality of foraminous structures 140 from FIG. 1 is shown. This section 200 shows the plurality of foraminous structures arranged in an imbricated pattern, wherein each tile 210 has a hexagonal shape with more than one foramen 220, i.e., holes. Similarly, FIG. 3 shows a different example embodiment of the layer of plurality of foraminous structures 140 from FIG. 1. In FIG. 3, the imbricated pattern of the example section 300 of the plurality of foraminous structures has circular tiles 310 with multiple foramen 320 per tile 310. In yet another example embodiment of a section of the layer of the plurality of foraminous structures 140 in FIG. 1 is where each tile 410 is trapezoidal with multiple in the overall, non-imbricated pattern. Other example shape of the individual tiles, such as 210 and 310 shown in FIGS. 2 and 3, respectively, may be a square 410, a triangle 430, or a crescent 450 as shown in FIGS. 4A-4C, respectively. An additional example is a dodecagon that is not depicted in the Figures. Hexagons and circles have shown to be most promising shapes because of their uniformity of energy dissipation from incoming hits.

Flexibility of the device 100 in FIG. 1 is assisted by the imbricated patterns of the plurality of foraminous structures shown in FIGS. 2 and 3. Here, added flexibility is achieved because each of the tiles 210, 310 in FIGS. 2 and 3, respectively, pivot off each other. Acceptable thicknesses for the layer of the plurality of foraminous structures 140 in FIG. 1 may vary. For example, when titanium and aluminum discus-shaped tiles are used, a 0.270 inch thickness with tapered edges for the tiles has proven effective. However, less thickness, such as between 0.020 and 0.080 inches, is required for antiballistic and/or anti-stab effectiveness for the device 100 when carbon nanotubes or composite nanotube pressed hexagon tiles are used.

Just as the shape of the tiles may vary, so may the shape of the foramen. FIG. 4A-4C shows tiles 410, 430, and 450, each of the which have foramen 420, 440, and 460 with different example shapes. Specifically, foramen 420 is oval in shape, foramen 440 is circular in shape and densely populated within the tile 430, and foramen 460 is line-shaped. Although it may seem counter-intuitive that foramen, i.e., holes, may be used as a component in constructing antiballistic and/or anti-stab devices, such as device 100 in FIG. 1, the foramen remove additional weight that would otherwise be part of the device 100 and are effective in adding penetration-resistance if strategically placed in the patterned layout of the plurality of foraminous structures so as to remove unnecessary redundancies of metal on metal for example, e.g., FIGS. 2 and 3. That is, the chosen pattern of the plurality of foraminous structures, each of which have one or more foramen, borrows on the known concept that a honeycomb is stronger pound per pound than a solid. In suitable, example embodiments, each of the foramen may be between 0.003 and 0.250 inches in width.

While the foregoing is directed to example embodiments of the disclosed invention, other and further embodiments of the invention may be devised without departing from the basic scope thereof, and the scope thereof is determined by the claims, which may be read in light of the foregoing disclosure, that follow.

What is claimed is:

1. A penetration-resistant device, comprising:
a first substrate having a light weight and a high tensile strength;
a second substrate having the light weight and the high tensile strength;
an adhesive between and in contact with the first substrate and the second substrate; and
a plurality of foraminous structures that that are in contact with the adhesive and that are located in between the first substrate and the second substrate.

2. The device of claim 1, further comprising the plurality of foraminous structures arranged in an imbricated pattern.

3. The device of claim 1, further comprising one or more additional substrates, wherein each of the one or more additional substrates is in contact with the adhesive and a substrate selected from the group consisting of the first substrate, the second substrate, and another of the one or more additional substrates.

4. The device of claim 1, further comprising a water-repellent coating on exterior portions of the first substrate and the second substrate rather than in between the first substrate and the second substrate where the adhesive is located.

5. The device of claim 4, wherein the water-repellent coating comprises an ultrasonically woven nylon bag enveloping the device.

6. The device of claim 1, further comprising a water-repellent coating in between the first substrate and the second substrate where the adhesive is located.

7. The device of claim 6, wherein the water-repellent coating comprises a silicone rubber adhesive used as the adhesive.

8. The device of claim 1, wherein the first substrate comprises a antiballistic substance.

9. The device of claim 1, wherein the first substrate comprises an anti-stab substance.

10. The device of claim 1, wherein the first substrate comprises a low hygroscopic substance.

11. The device of claim 1, wherein the first substrate comprises a fabric.

12. The device of claim 11, wherein the fabric comprises Kevlar®.

13. The device of claim 11, wherein the fabric comprises Twaron®.

14. The device of claim 11, wherein the fabric comprises Evoflex™.

15. The device of claim 11, wherein the fabric comprises M5®.

16. The device of claim 11, wherein the fabric comprises polyethylene.

17. The device of claim 11, wherein the fabric comprises nylon.

18. The device of claim 11, wherein the fabric comprises a woven fabric.

19. The device of claim 11, wherein the fabric comprises a non-woven woven fabric.

20. The device of claim 1, wherein the first substrate comprises a flexible substance.

21. The device of claim 1, wherein the second substrate comprises an antiballistic substance.

22. The device of claim 1, wherein the second substrate comprises a low hygroscopic substance.

23. The device of claim 1, wherein the second substrate comprises a fabric.

24. The device of claim 1, wherein the second substrate comprises a flexible substance.

25. The device of claim 1, wherein the second substrate comprises an anti-stab substance.

26. The device of claim 1, wherein the adhesive comprises an acrylic adhesive.

27. The device of claim 1, wherein the adhesive comprises a silicone adhesive.

28. The device of claim 1, wherein the adhesive comprises a petroleum-based adhesive.

29. The device of claim 1, wherein the foraminous structures comprise one or more metals.

30. The device of claim 30, wherein the one or more metals comprise titanium.

31. The device of claim 30, wherein the one or more metals comprise aluminum.

32. The device of claim 30, wherein the one or more metals comprise steel.

33. The device of claim 30, wherein the one or more metals comprise one or more alloys.

34. The device of claim 1, wherein the foraminous structures comprise one or more nano-metals.

35. The device of claim 1, wherein the foraminous structures comprise nano-carbon tubes.

36. The device of claim 1, wherein the foraminous structures comprise non-porous, casted metals with tempering capabilities.

37. The device of claim 1, wherein the foraminous structures comprise powdered metal composites.

38. The device of claim 1, wherein the foraminous structures comprise a molded plastic.

39. The device of claim 1, wherein each of the foraminous structures has a shape.

40. The device of claim 39, wherein the shape comprises a hexagon.

41. The device of claim 39, wherein the shape comprises a circle.

42. The device of claim 39, wherein the shape comprises a square.

43. The device of claim 39, wherein the shape comprises a dodecagon.

44. The device of claim 39, wherein the shape comprises a triangle.

45. The device of claim 39, wherein the shape comprises a trapezoid.

46. The device of claim 39, wherein the shape comprises a crescent.

47. The device of claim 1, wherein the foraminous structures comprise perforations in shapes.

48. The device of claim 47, wherein the perforations comprise holes.

49. The device of claim 47, wherein the perforations comprise lines.

50. The device of claim 1, wherein the adhesive comprises a peel-off and release adhesive applied to each of the first substrate and the second substrate.

51. The device of claim 1, wherein the device comprises a shape for adhering to an article worn by an individual.

52. The device of claim 51, wherein the article comprises a vest.

53. The device of claim 51, wherein the article comprises a jacket.

54. The device of claim 51, wherein the article comprises a helmet.

55. The device of claim 51, wherein the article comprises a glove.

56. The device of claim 51, wherein the article comprises a pair of pants.

57. The device of claim 51, wherein the article comprises a shirt.

58. The device of claim 51, wherein the article comprises a pair of shoes.

59. The device of claim 51, wherein the article comprises a body suit.

60. The device of claim 51, wherein the shape is stitched into the article worn by an individual.

61. The device of claim 51, wherein the shape is glued into the article worn by an individual.

62. The device of claim 1, wherein the device comprises a shape suitable for adhering to a vehicle.

63. The device of claim 62, wherein the vehicle comprises a tank.

64. The device of claim 62, wherein the vehicle comprises a car.

65. The device of claim 62, wherein the shape is stitched to the vehicle.

66. The device of claim 62, wherein the shape is glued to the vehicle.

67. The device of claim 62, wherein the shape is bolted to the vehicle.
